(19) United States
(12) Patent Application Publication
(10) Pub. No.: US 2009/0045757 A1
(43) Pub. Date: Feb. 19, 2009

(54) DISCHARGE LAMP LIGHTER

(75) Inventors: Kengo Kimura, Niiza-shi (JP); Kazushige Hirata, Niiza-shi (JP); Jaehee Cho, Niiza-shi (JP); Toshihiro Nakano, Niiza-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sanken Electric Co., Ltd., Niiza-shi (JP)

(21) Appl. No.: 12/192,440

(22) Filed: Aug. 15, 2008

(30) Foreign Application Priority Data
Aug. 17, 2007 (JP) 2007-212831

(51) Int. Cl. H05B 41/36

(52) U.S. Cl. 315/297; 315/307

(57) ABSTRACT

A discharge lamp lighter has an abnormality detecting circuit 7 for detecting an abnormality in an electrical load. The abnormality detecting circuit 7 includes a reference voltage part Ra1, Rb1, Ra2, Rb2 for generating a first reference voltage Vb1 and a second reference voltage Vb2, a detection voltage part Rc1, Rd1, Rc2, Rd2 for generating a first detection voltage Vc1 and a second detection voltage Vc2, a first determining part CP1 for determining the presence of abnormality in the electrical load when the second detection voltage Vc2 is outside a predetermined range with the first reference voltage Vb1 and a second determining part CP2 for determining the presence of abnormality in the electrical load when the first detection voltage Vc1 is outside the predetermined range with the second reference voltage Vb2.

### BACKGROUND OF THE INVENTION

1. Field of the Invention

The present invention relates to a discharge lamp lighter for lighting a discharge lamp used in a liquid crystal display equipment or the like, particularly, an equipment using cold cathode fluorescent lamps.

2. Description of the Related Art

Japanese Patent Publication Laid-open No. 7-65972 discloses a discharge lamp lighter which outputs an alternating voltage at one end of a discharge lamp and includes an abnormality detecting circuit for detecting an abnormal condition of an electrical load.

This discharge lamp lighter includes a chopper circuit outputting a chopping voltage based on a lamp current (or tube current) of the discharge lamp, a DC/AC converter which generates an alternating voltage boosted by a transformer on the basis of the chopping voltage and impresses the alternating voltage on one end of the discharge lamp to light up it and a lamp current detector connected to the other end of the discharge lamp to detect a current flowing in the discharge lamp.

In the above-constructed discharge lamp lighter, if the electrical load has an abnormality and no lamp current is returned from the lamp current detector to the chopper circuit, the operation of transistors is stopped. Subsequently, with a time delay (by a predetermined time) performed by a time constant setting circuit, a voltage is impressed on an idle period controller to stop the power output of a feedback control IC toward the chopper circuit. As a result, any high voltage is not impressed on a transformer in the DC/AC converter, preventing heat generation of the transformer.

### SUMMARY OF THE INVENTION

However, the above-mentioned discharge lamp lighter is nothing but a circuit that is applicable only in outputting an alternating current voltage to one end of the discharge lamp. Additionally, in the above publication, there is no description about the lump lighter's operation at burst dimming.

If the above-mentioned discharge lamp lighter is requested to perform burst dimming, it is necessary to establish a timer period of a protection circuit (i.e. the above time constant setting circuit and the idle period controller) sufficiently longer than a burst dimming cycle.

With the above-mentioned constitution, however, it should be noted that if the electrical load has an abnormality actually, the protection circuit may be partially broken in the timer period.

Under the above-mentioned situation, an object of the present invention is to provide a discharge lamp lighter which allows the timer period of the protection circuit to be established shorter than the burst dimming cycle and which can accomplish a safe and optimal protection of a discharge lamp.

In order to solve the above-mentioned problem, according to a first aspect of the present invention, there is provided a discharge lamp lighter for outputting a voltage to both ends of a discharge lamp, comprising an abnormality detecting circuit for detecting an abnormality in an electrical load, the abnormality detecting circuit including:

a reference voltage part for generating a first reference voltage obtained by dividing a voltage, which has been obtained as a result of rectifying and smoothening a terminal voltage at one end of the discharge lamp, by a first constant ratio, and a second reference voltage obtained by dividing another voltage, which has been obtained as a result of rectifying and smoothening another terminal voltage at the other end of the discharge lamp, by the first constant ratio;

a detection voltage part for generating a first detection voltage obtained by dividing the voltage, which has been obtained as a result of rectifying and smoothening the terminal voltage at one end of the discharge lamp, by a second constant ratio, and a second detection voltage obtained by dividing the other voltage, which has been obtained as a result of rectifying and smoothening the other terminal voltage at the other end of the discharge lamp, by the second constant ratio;

a first determining part for determining that the electrical load has an abnormality when the second detection voltage is outside a predetermined range with respect to the first reference voltage; and

a second determining part for determining that the electrical load has an abnormality when the first detection voltage is outside the predetermined range with respect to the second reference voltage.

According to a second aspect of the present invention, there is also provided a discharge lamp lighter for outputting voltages to respective one ends of multiple (N: N≧2) discharge lamps, comprising an abnormality detecting circuit for detecting an abnormality in an electrical load, the abnormality detecting circuit including, on sequential definition of the discharge lamps as a first discharge lamp˜an N^{th}. discharge lamp:

a reference voltage part for generating a first reference voltage˜an N^{th}. reference voltage obtained by dividing voltages, which have been obtained as a result of rectifying and smoothening terminal voltages at respective one ends of the discharge lamps, by a first constant ratio; a detection voltage part for generating a first detection voltage˜an N^{th}. detection voltage obtained by dividing the voltages, which have been obtained as a result of rectifying and smoothening the terminal voltages at respective one ends of the discharge lamps, by a second constant ratio; and

multiple (N) determining parts for determining that the electrical load has an abnormality, each of the determining parts being adapted so as to:

select one detection voltage from the first detection voltage˜the N^{th}. detection voltage and also one reference voltage from the first reference voltage˜then N^{th}. reference voltage, the selected detection voltage having its sequential number different from a sequential number of the selected reference voltage;

compare the selected detection voltage with the selected reference voltage; and

determine that the electrical load has an abnormality when the selected detection voltage is outside the predetermined range with respect to the selected reference voltage.

### BRIEF DESCRIPTION OF THE DRAWINGS

FIG. 1 is a circuit diagram showing a constitution of a discharge lamp lighter in accordance with a first embodiment of the present invention.

FIG. 2 is a view showing operating waveforms of driving signals of respective switching elements of the discharge lamp lighter of the first embodiment.

FIG. 3 is an operating waveform diagram of burst dimming of the discharge lamp lighter of the first embodiment.

FIG. 4 is a circuit diagram showing a constitution of a discharge lamp lighter in accordance with a second embodiment of the present invention.

FIG. 5A is a partial circuit diagram showing a part of a discharge lamp lighter in accordance with a third embodiment of the present invention, and FIG. 5B is a partial circuit diagram showing the remaining part of the discharge lamp lighter of the third embodiment.

FIG. 6 is a circuit diagram showing a main constitution of an abnormality detection circuit of the discharge lamp lighter of the third embodiment.

### DETAILED DESCRIPTION OF THE PREFERRED EMBODIMENTS

Referring to drawings, various embodiments of the present invention will be described below, in detail.

### 1^{st}. Embodiment

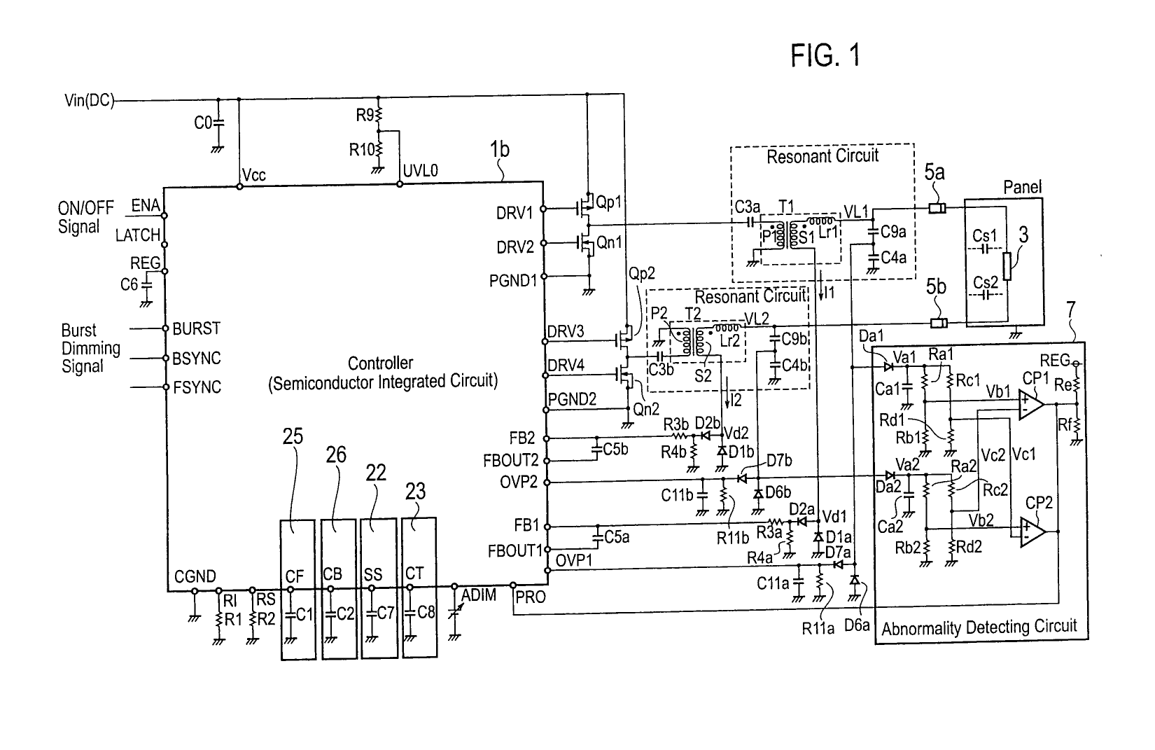

FIG. 1 is a circuit diagram showing a constitution of a discharge lamp lighter in accordance with a first embodiment of the present invention. In the embodiment, the discharge lamp lighter is used in a large-sized liquid crystal panel particularly. In the discharge lamp lighter, a discharge lamp 3 is connected, on both sides thereof, with a connector 5a and a connector 5b. The discharge lamp lighter further includes resonant circuits having transformers T1, T2 and switching elements Qp1, Qn1, Qp2 and Qn2 applying the current to the resonant circuits to produce a voltage in opposite phase on both ends of the discharge lamp 3 in order to convert a direct current to a symmetric alternating current. The discharge lamp 3 is formed by a cold cathode fluorescent lamp (CCFL).

In FIG. 1, a series circuit composed of a high-side P-channel MOSFET Qp1 (referred to as “P-FET Qp1” after) and a low-side N-channel MOSFET Qn1 (referred to as “N-FET Qn1” after) is interposed between a direct-current source Vin and ground. Further, a series circuit having a capacitor C3a and a primary winding P1 of the transformer T1 is connected between a connection point between the P-FET Qp1 and the N-FET Qn1 and the ground GND. The P-FET Qp1 is supplied, at its source, with the direct-current source Vin. The P-FET Qp1 has a gate connected to a terminal DRV1 of a control circuit (controller) 1b. While, N-FET Qn1 has a gate connected to a terminal DRV2 of the controller 1b.

In the transformer T1, a secondary winding S1 has one end connected to one pole of the discharge lamp 3 through the connector 5a. In the diagram, Lr1 designates a leakage inductance component of the transformer T1. The other end of the secondary winding S1 is connected to a cathode of a diode D1a and an anode of a diode D2a. The diodes D1a, D2a and a resistance 4a constitute a tube-current detecting circuit that detects a current I1 flowing in the secondary winding S1 and further outputs a voltage proportional to the detected current to one terminal of an inside error amplifier through a resistance R3a and a terminal FB1 of the controller 1b.

A series circuit composed of a capacitor C9a and a capacitor C4a is interposed between one end of the discharge lamp 3 and the ground. A connection point between the capacitor C9a and the capacitor C4a is connected to a cathode of a diode D6a and an anode of a diode D7a. The diodes D6a, D7a and resistances R11a, C11a constitute a rectifying-and-smoothing circuit that detects a voltage proportional to an output voltage VL1 and further outputs the detected voltage to a terminal OVP1 of the controller 1b.

A series circuit composed of a P-channel MOSFET Qp2 (referred to as “P-FET Qp2” after) and a N-channel MOSFET Qn2 (referred to as “N-FET Qn2 after) is interposed between the direct-current source Vin and the ground. Further, a series circuit having a capacitor C3b and a primary winding P2 of the transformer T2 is connected between a connection point between the P-FET Qp2 and the N-FET Qn2 and the ground GND. The P-FET Qp2 is supplied, at its source, with the direct-current source Vin. The P-FET Qp2 has a gate connected to a terminal DRV3 of the controller 1b. While, N-FET Qn2 has a gate connected to a terminal DRV4 of the controller 1b.

In the transformer T2, a secondary winding S2 has one end connected to the other pole of the discharge lamp 3. In the diagram, Lr2 designates a leakage inductance component of the transformer T2. The other end of the secondary winding S2 is connected to a cathode of a diode D1b and an anode of a diode D2b. The diodes D1a, D2a and a resistance R4b constitute a tube-current detecting circuit that detects a current I2 flowing in the secondary winding S2 and further outputs a voltage proportional to the detected current to one terminal of the inside error amplifier through a resistance R3b and a terminal FB2 of the controller 1b.

A series circuit composed of a capacitor C9b and a capacitor C4b is interposed between the other end of the discharge lamp 3 and the ground. A connection point between the capacitor C9b and the capacitor C4b is connected to a cathode of a diode D6b and an anode of a diode D7b. The diodes D6b, D7b and resistances R11b, C11b constitute a rectifying-and-smoothing circuit that detects a voltage proportional to an output voltage VL2 and further outputs the detected voltage to a terminal OVP2 of the controller 1b.

The controller 1b includes a first control part (not shown) for controlling the switching elements Qp1, Qn1 with a phase difference of 180 degrees by a first PWM control signal at a pulse width corresponding to the current flowing through the secondary winding S1 of the transformer T1 and a second control part (also not shown) for controlling the switching elements Qp2, Qn2 with a phase difference of 180 degrees at a pulse width corresponding to the current flowing through the secondary winding S2 of the transformer T2.

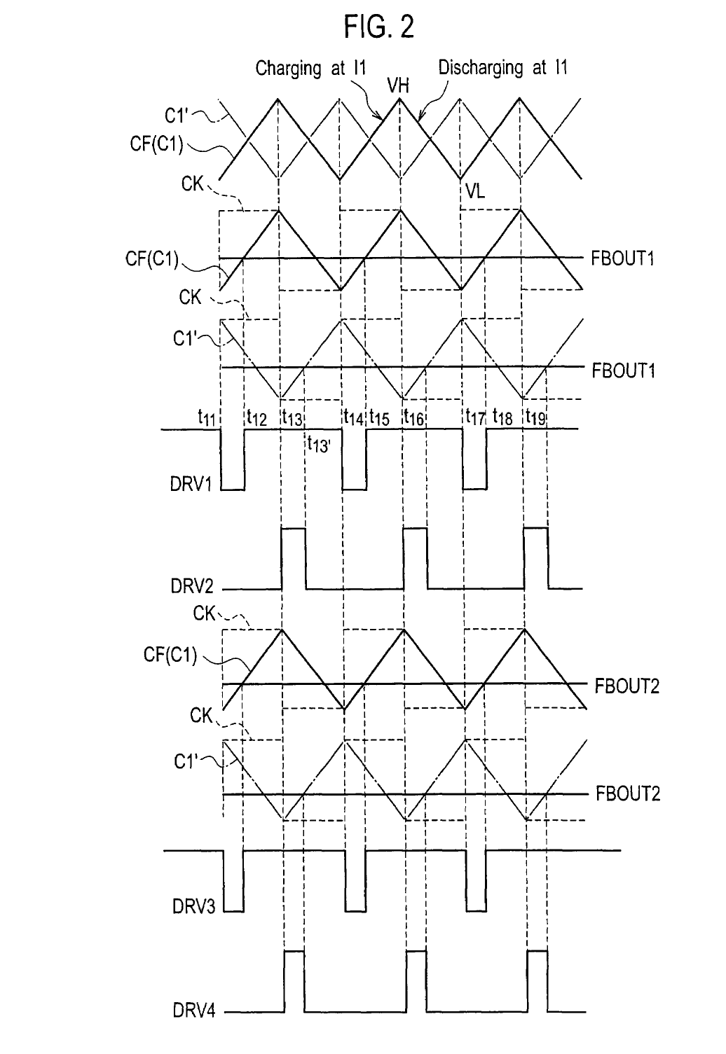

The operation of the controller 1b will be described with reference to FIG. 2. The first control part amplifies a rectifying-and-smoothing voltage inputted through the terminal FB1, that is, a first error voltage FBOUT1 between the voltage corresponding to the current flowing through the secondary winding S1 and a first threshold voltage, compares the first error voltage FBOUT1 with a triangular wave signal CF (C1) generated from a triangular wave oscillator 25 and produces the PWM control signal having the pulse width corresponding to the current flowing through the secondary winding S1. Additionally, the first control part produces a drive signal DRV1 by inversing the PWM control signal and outputs the drive signal DRV1 to the gate of the switching element Qp1.

The first control part compares the first error voltage FBOUT1 with an inversion signal CF (C1′) obtained by inverting the triangular signal CF (C1) of the triangular wave oscillator 25 at a midpoint between upper and lower limits, produces the PWM control signal having the pulse width corresponding to the current flowing through the secondary winding S1 and outputs the PMW control signal as a drive signal DRV2 to the gate of the switching element Qn1.

The second control part amplifies a rectifying-and-smoothing voltage inputted through the terminal FB2, that is, a second error voltage FBOUT2 between the voltage corresponding to the current flowing through the secondary winding S2 and a second threshold voltage, compares the second error voltage FBOUT2 with the triangular wave signal CF (C1) generated from the triangular wave oscillator 25 and produces the PWM control signal having the pulse width corresponding to the current flowing through the secondary winding S2. Additionally, the first control part produces a drive signal DRV3 by inversing the PWM control signal and outputs the drive signal DRV3 to the gate of the switching element Qp2. The second control part compares the second error voltage FBOUT2 with the inversion signal CF (C1′) obtained by inverting the triangular signal CF (C1) of the triangular wave oscillator 25 at a midpoint between upper and lower limits, produces the PWM control signal having the pulse width corresponding to the current flowing through the secondary winding S2 and outputs the PWM control signal as a drive signal DRV4 to the gate of the switching element Qn2.

Subsequently, the P-FET Qp1 and the N-FET Qn1 are alternately turned on/off by the drive signals DRV1, DRV2 and similarly, the P-FET Qp2 and the N-FET Qn2 are also turned on/off by the drive signals DRV3, DRV4. Based on the waveform of the triangular wave signal CF (C1), this switching ON/OFF operation is carried out with the same frequency and the same phase on the ground of the feedback control of the first and the second error voltages. In this way, the discharge lamp 3 is supplied with a reverse-phase power, and the current flowing through the discharge lamp 3 is controlled to a predetermined value.

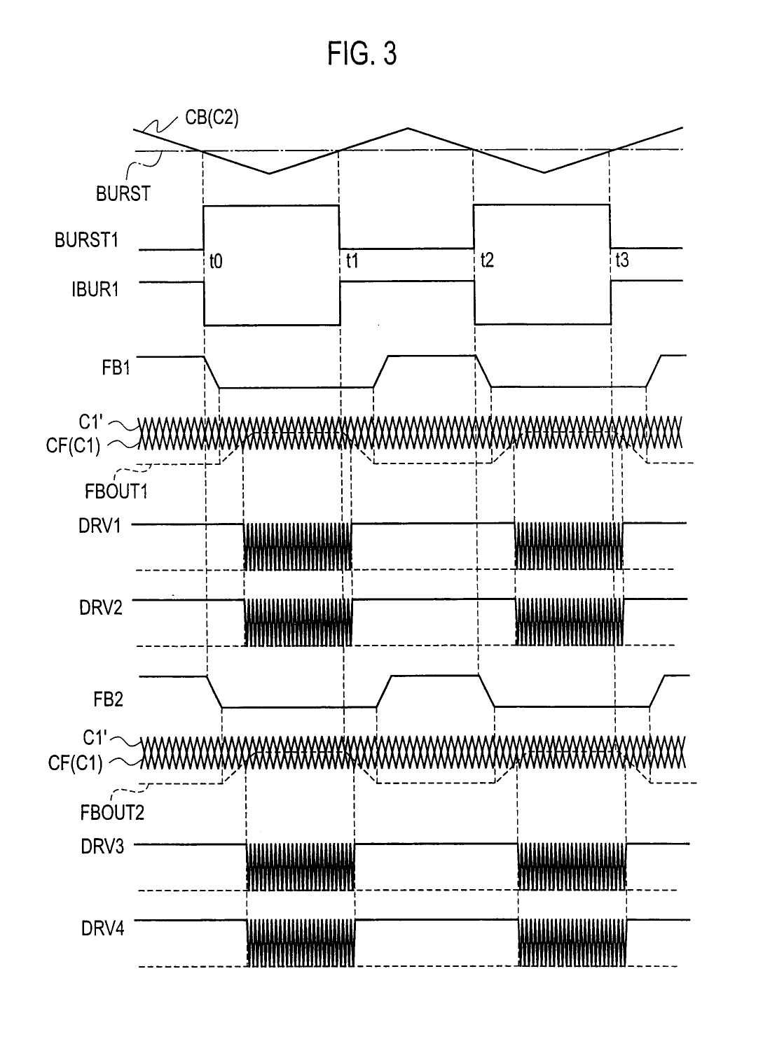

FIG. 3 is an operating waveform diagram of burst dimming of the discharge lamp lighter of the first embodiment. In the discharge lamp lighter, a low-frequency oscillator's capacitor C2 is connected to a terminal CB and charged/discharged with a current I1, which is optionally established with a constant-current determining resistance R1 by a current mirror circuit (not shown) in the controller 1b, so that a low-frequency triangular wave signal CB (C2) is generated. This triangular wave signal CB (C2) has the same inclination in rising as that in trailing.

The controller 1b compares a voltage of the capacitor C2 of the terminal CB with the voltage inputted to a terminal BURST. If the voltage at the terminal BURST is lower than the voltage of the capacitor C2 (i.e. OFF period in burst dimming: time t1˜t2), it is executed to allow current to flow from the terminals FB1, FB2 so as to change the first and the second error voltages FBOUT1, FBOUT2 in a direction to squeeze the power supply to the discharge lamp 3. Thus, the output is intermittently oscillated to reduce the power supply to the discharge lamp 3, accomplishing burst dimming. In the controller 1b, a burst dimming triangular-wave oscillator 26 outputs a burst dimming signal for intermittent power supply at burst dimming to the first control part and the second control part simultaneously.

(Re. Abnormality Detecting Circuit)

Next, the abnormality detecting circuit as one feature of the first embodiment will be described below. In FIG. 1, the abnormality detecting circuit 7 is adapted so as to detect the abnormality of the discharge lamp 3 by comparing a terminal voltage at one end of the lamp 3 with another terminal voltage at the other end.

Notations “Cs1” and “Cs2” denote respective stray capacitances between a panel and a flame ground. On one side of the discharge lamp 3, a midpoint between the capacitor C9a and the capacitor C4a is connected to the anode of the diode Da1. In the diode Da1, its cathode is connected to one end of a capacitor Ca1, one end of a resistance Ra1 and one end of a resistance Rc1. The other end of the capacitor Ca1 is connected to ground. The other end of the resistance Ra1 is connected to one end of a resistance Rb1, while the other end of the resistance Rb1 is connected to ground. The other end of the resistance Rc1 is connected to one end of a resistance Rd1, while the other end of the resistance Rd1 is connected to ground.

A divided voltage at the connection point between the resistance Ra1 and the resistance Rb1 corresponds to a voltage obtained by dividing a both-end voltage of the capacitor Ca1 by the resistance Ra1 and the resistance Rb1. This divided voltage is outputted, as a first reference voltage Vb1, to a positive (+) input terminal of a comparator CP1. Similarly, a divided voltage at the connection point between the resistance Rc1 and the resistance Rd1 corresponds to a voltage obtained by dividing the both-end voltage of the capacitor Ca1 by the resistance Rc1 and the resistance Rd1. This divided voltage is outputted, as a first detection voltage Vc1, to a negative (−) input terminal of a comparator CP2.

On the other side of the discharge lamp 3, a midpoint between the capacitor C9b and the capacitor C4b is connected to the anode of the diode Da2. In the diode Da2, its cathode is connected to one end of a capacitor Ca2, one end of a resistance Ra2 and one end of a resistance Rc2. The other end of the capacitor Ca2 is connected to ground. The other end of the resistance Ra2 is connected to one end of a resistance Rb2, while the other end of the resistance Rb2 is connected to ground. The other end of the resistance Rc2 is connected to one end of a resistance Rd2, while the other end of the resistance Rd2 is connected to ground.

A divided voltage at the connection point between the resistance Ra2 and the resistance Rb2 corresponds to a voltage obtained by dividing a both-end voltage of the capacitor Ca2 by the resistance Ra2 and the resistance Rb2. This divided voltage is outputted, as a second reference voltage Vb2, to a positive (+) input terminal of the comparator CP2. Similarly, a divided voltage at the connection point between the resistance Rc2 and the resistance Rd2 corresponds to a voltage obtained by dividing the both-end voltage Va2 of the capacitor Ca2 by the resistance Rc2 and the resistance Rd2. This divided voltage is outputted, as a second detection voltage Vc2, to a negative (−) input terminal of the comparator CP1.

All of the resistances Ra1, Rb1, Ra2, Rb2, the first reference voltage Vb1 and the second reference voltage Vb2 constitute a reference voltage part of the invention. While, all of the resistances Rc1, Rd1, Rc2, Rd2, the first detection voltage Vc1 and the second detection voltage Vc2 constitute a detection voltage part of the invention.

The comparator CP1 (a first determining part of the invention), which is a type of open collector, compares the first reference voltage Vb1 at the connection point between the resistance Ra1 and the resistance Rb1 with the second detection voltage at the connection point between the resistance Rc2 and the resistance Rd2. If the second detection voltage Vc2 is outside a predetermined range with respect to the first reference voltage Vb1, then the comparator CP1 determines that the discharge lamp 3 is in its abnormal condition and further outputs the determination result to a terminal PRO of the controller 1b.

The comparator CP2 (a second determining part of the invention), which is also a type of open collector, compares the second reference voltage Vb2 at the connection point between the resistance Ra2 and the resistance Rb2 with the first detection voltage Vc1 at the connection point between the resistance Rc1 and the resistance Rd1. If the first detection voltage Vc1 is outside a predetermined range with respect to the second reference voltage Vb2, then the comparator CP2 determines that the discharge lamp 3 is in the abnormal condition and further outputs the determination result to the terminal PRO of the controller 1b.

A series circuit composed of a resistance Re and a resistance Rf is connected between a power supply voltage REG and ground. A connection point between the resistance Re and the resistance Rf is connected to an output terminal of the comparator CP1 and an output terminal of the comparator CP2.

Next, the operation of the above-constructed abnormality detecting circuit 7 will be described below. As for respective constants of the resistances, there are established relationships of Ra1=Ra2, Rb1=Rb2, Rc1=Rc2 and Rd1=Rd2. As for respective constants of the capacitors, there are established relationships of C9a=C9b and C4a=C4b.

First, the diode Da1 has its anode to which a divided voltage of the voltage VL1 by the capacitor C9a and the capacitor C4a is impressed. This divided voltage is rectified and smoothened by the diode Da1 and the capacitor Ca1, realizing a voltage Va1 at both ends of the capacitor Ca1. The first reference voltage Vb1 is a voltage obtained by dividing the voltage Va1 by the resistances Ra1, Rb1. The first detection voltage Vc1 is a voltage obtained by dividing the voltage Va1 by the resistances Rc1, Rd1.

The diode Da2 has its anode to which a divided voltage of the voltage VL2 by the capacitor C9b and the capacitor C4b is impressed. This divided voltage is rectified and smoothened by the diode Da2 and the capacitor Ca2, realizing a voltage Va2 at both ends of the capacitor Ca2. The second reference voltage Vb2 is a voltage obtained by dividing the voltage Va2 by the resistances Ra2, Rb2. The second detection voltage Vc2 is a voltage obtained by dividing the voltage Va2 by the resistances Rc2, Rd2.

Thus, if the electrical load does not have an abnormality, the voltage VL1 and the voltage VL2 are substantially equal to each other in terms of actual value although the former is different from the latter in phase by 180 degrees. Therefore, among the first reference voltage Vb1, the second reference voltage Vb2, the first detection voltage Vc1 and the second detection voltage Vc2, there are established the following relationships of Vb1≈Vb2 and Vc1≈Vc2. Further, it is also established that when there is no abnormality in the electrical load, a value of Vc1≈Vc2 becomes smaller than a value of Vb1≈Vb2 by e.g. 10% of the latter value.

When the electrical load has no abnormality, there are established the following inequalities of Vb1>Vc2 and Vb2>Vc1. Thus, the comparator CP1 and the comparator CP2 together generate outputs of H(high)-level. Consequently, the voltage at a (protective) terminal PRO becomes equal to a voltage by dividing the power supply voltage REG by the resistances Re, Rf, that is, the input voltage of an inside window comparator connected to the terminal PRO has an input voltage that is neither H-level nor L(low)-level voltage. As a result, a protection circuit is not activated so as to keep on outputting the power to the discharge lamp 3.

Meanwhile, if the electrical load is in the abnormal condition, there is produced a difference in potential between the voltage VL1 and the voltage VL2. For instance, if the voltage VL1 is higher than the voltage VL2, the comparator CP1 outputs a H-level signal, while the comparator CP2 outputs a L-level signal, so that the voltage at the terminal PRO becomes L-level.

On the other hand, if the voltage VL2 is higher than the voltage VL1, the comparator CP1 outputs a L-level signal, while the comparator CP2 outputs a H-level signal, so that the voltage at the terminal PRO becomes L-level.

In the controller 1b, therefore, after a predetermined period established in a timer circuit 23 (i.e. timer period) has passed, an output shutdown circuit is activated to stop outputting of voltage (power) to the discharge lamp 3. It is noted that the predetermined period depends on a capacitor C8 connected to a terminal CT of the controller 1b.

According to the first embodiment, by comparing one terminal voltage of the discharge lamp 3 with the other terminal voltage, there is no possibility of falsely detecting the abnormality in the electrical load because all of the voltages Vb1, Vb2, Vc1, Vc2 are subjected to brownout at the same rate during an OFF period at burst dimming. As a result, it is possible to establish the above timer period in the protection circuit shorter than a burst dimming cycle, accomplishing a safe and optimal protection of the discharge lamp 3.

In this way, with the simplified structure, it is possible to detect a wide variety of abnormalities occurring in the electrical load, for example, short circuit between one end of the discharge lamp 3 and the frame ground of the panel, disconnection of either the connector 5a or the connector 5b, one opened end of the discharge lamp 3 and so on.

That is, if only a difference in potential is produced between one terminal voltage of the lamp 3 and the other terminal voltage, the discharge lamp lighter of the invention could detect all of the abnormal conditions in the electrical load, for example, fragility in a glass tube, abnormal glow discharge (i.e. slow leakage), arc discharge to peripheral equipments and patterns, which may be occurred in the final days of the discharge lamp 3.

As for the discharge lamp as the electrical load, it is not always a cold cathode fluorescent lamp and therefore, the other discharge lamp, such as EEFL (External Electrode Fluorescent Lamp), may constitute the discharge lamp of the invention. Alternatively, there may be adopted an equivalent EEEL load where a capacitor is connected to each terminal of a cold cathode fluorescent lamp in series, for the electrical load.

### 2^{nd}. Embodiment

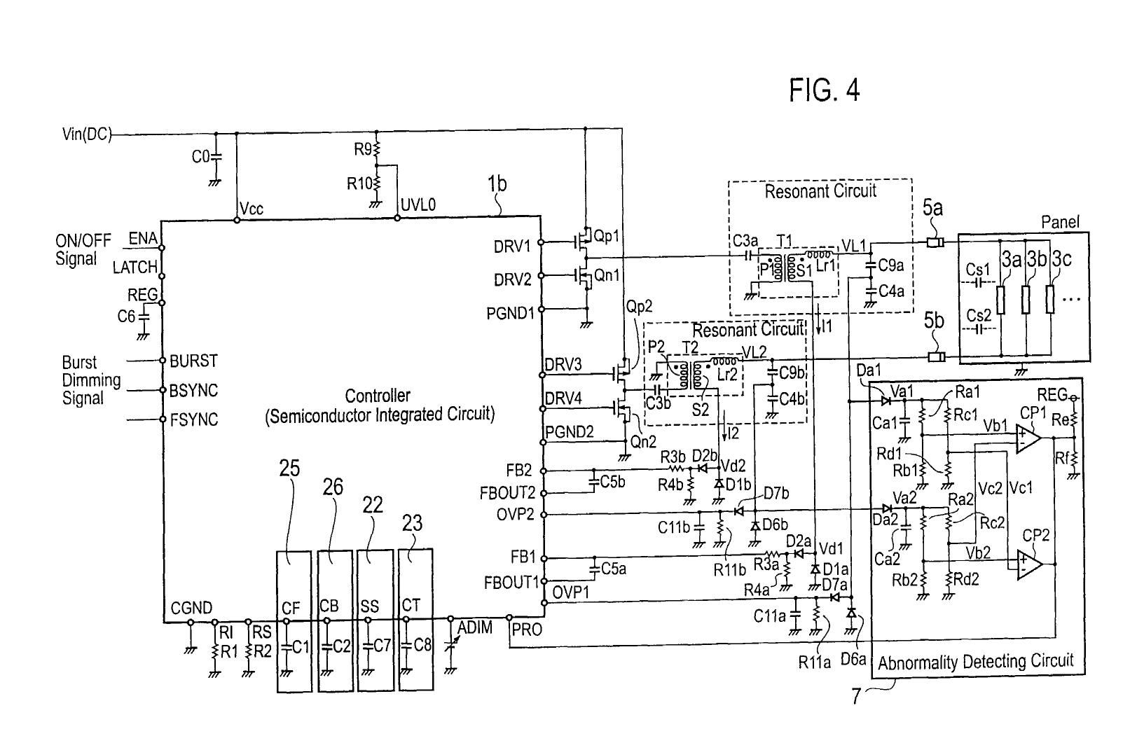

FIG. 4 is a circuit diagram showing a constitution of a discharge lamp lighter in accordance with a second embodiment of the present invention. The discharge lamp lighter of this embodiment differs from the previous lighter of the first embodiment in that a plurality of parallel-connected discharge lamps 3a, 3b , 3c, . . . are interposed between the connector 5a and the connector 5b.

In the discharge lamp lighter of the second embodiment, if the electrical load is formed by the discharge lamps each exhibiting positive impedance characteristic, then it is possible to regard the arrangement where a plurality of discharge lamps 3a, 3b , 3c, . . . are connected in parallel as an electrical load composed of a signal discharge lamp, realizing the similar operation and effect as the discharge lamp lighter of the first embodiment.

### 3^{rd}. Embodiment

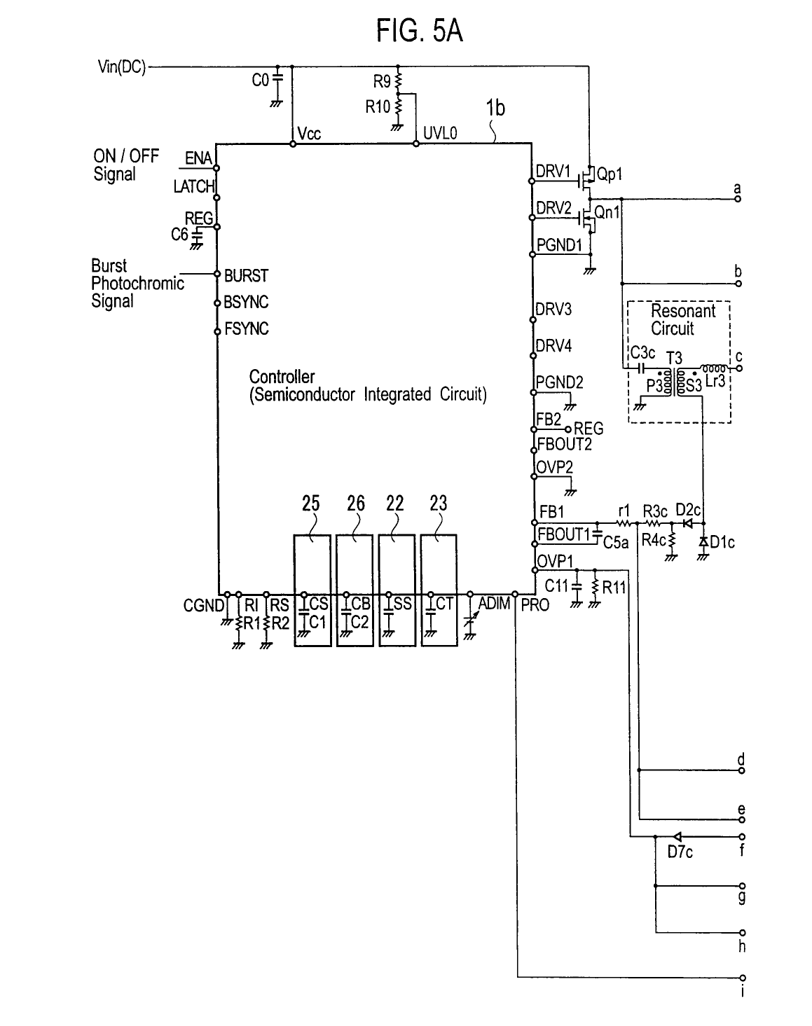

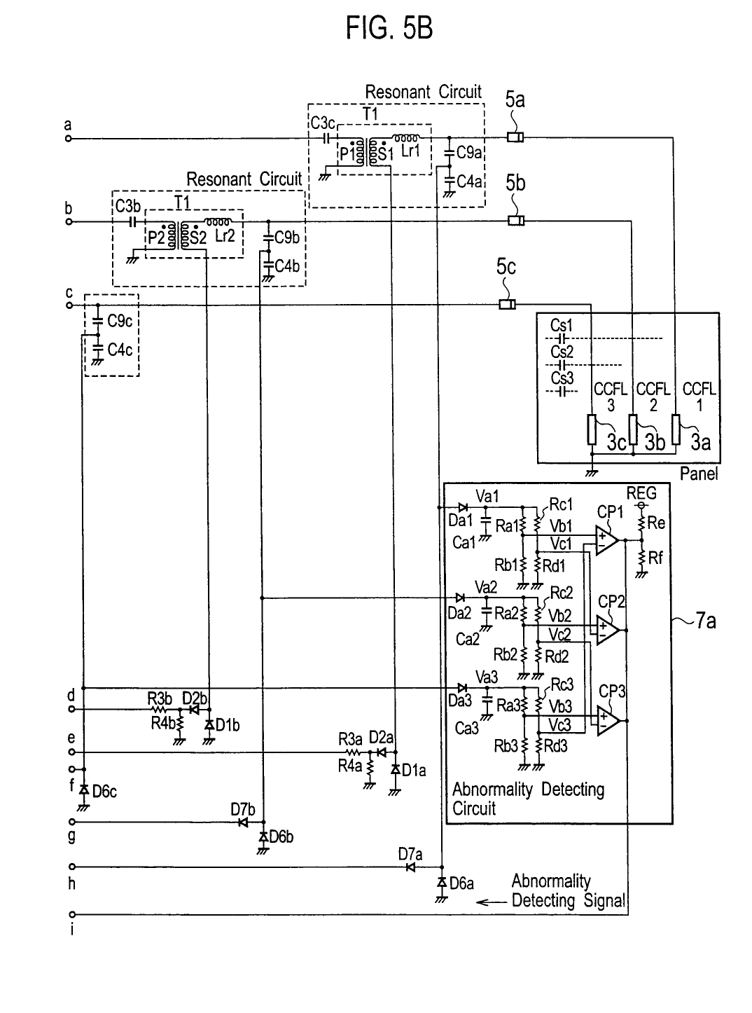

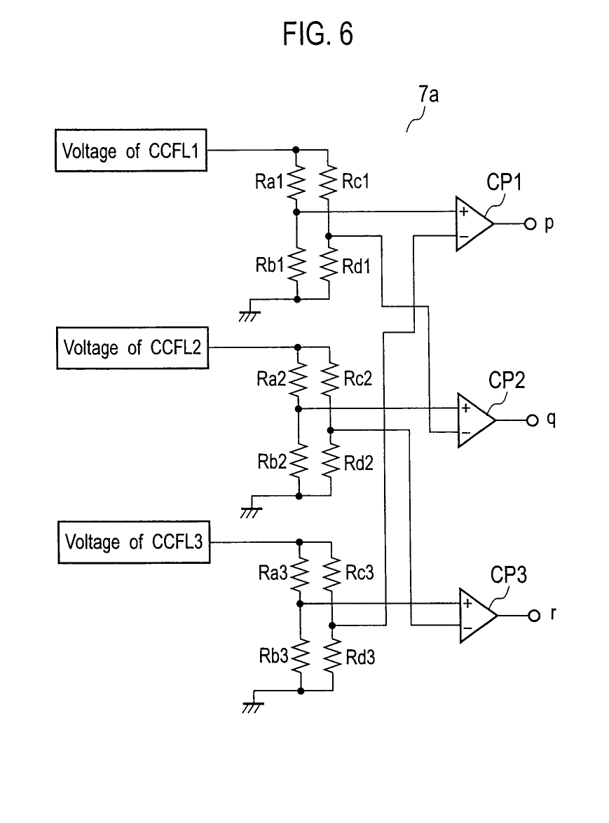

FIG. 5A is a partial circuit diagram showing a part of a discharge lamp lighter in accordance with a third embodiment of the present invention. FIG. 5B is a partial circuit diagram showing the remaining part of the discharge lamp lighter of the third embodiment. FIG. 6 is a circuit diagram showing a main constitution of an abnormality detection circuit of the discharge lamp lighter of the third embodiment.

In FIG. 5A, a series circuit composed of the P-FET Qp1 and the N-FET Qn1 is interposed between the direct-current source Vin and the ground. Further, a connection point between the P-FET Qp1 and the N-FET Qn1 is connected to the primary winding P1 of the transformer T1 of the resonant circuit through the capacitor C3a. The secondary winding S1 of the transformer T1 is connected to one end of the discharge lamp 3a through the connector 5a.

The connection point between the P-FET Qp1 and the N-FET Qn1 is connected to the primary winding P2 of the transformer T2 of the resonant circuit through the capacitor C3b . The secondary winding S2 of the transformer T2 is connected to one end of the discharge lamp 3b through the connector 5b.

The connection point between the P-FET Qp1 and the N-FET Qn1 is connected to the primary winding P3 of the transformer T3 of the resonant circuit through the capacitor C3c. The secondary winding S3 of the transformer T3 is connected to one end of the discharge lamp 3c through the connector 5c. The other ends of the discharge lamps 3a, 3b , 3c are connected to ground.

The P-FET Qp1 is supplied, at its source, with the direct-current source Vin. The P-FET Qp1 has a gate connected to the terminal DRV1 of the controller 1b. While, N-FET Qn1 has a gate connected to the terminal DRV2 of the controller 1b.

In FIGS. 5A and 5B, Lr1, Lr2 and Lr3 designate respective leakage inductance components of the transformers T1, T2 and T3.

The other end of the secondary winding S1 of the transformer T1 is connected to a cathode of the diode D1a and an anode of the diode D2a. The diodes D1a, D2a and the resistance 4a constitute a tube-current detecting circuit that detects a current I1 flowing in the secondary winding S1 and further outputs a voltage proportional to the detected current to one terminal of an inside error amplifier through resistances R3a, r1 and the terminal FB1 of the controller 1b.

A series circuit composed of the capacitor C9a and the capacitor C4a is interposed between one end of the discharge lamp 3 and the ground. A connection point between the capacitor C9a and the capacitor C4a is connected to the cathode of the diode D6a and the anode of the diode D7a. The diodes D6a, D7a and the resistances R11a, C11a constitute a rectifying-and-smoothing circuit that detects a voltage proportional to an output voltage VL1 and further outputs the detected voltage to the terminal OVP1 of the controller 1b.

The other end of the secondary winding S2 of the transformer T2 is connected to the cathode of the diode D1b and the anode of the diode D2b. The diodes D1a, D2a and the resistance R4b constitute a tube-current detecting circuit that detects the current I2 flowing in the secondary winding S2 and further outputs a voltage proportional to the detected current to one terminal of the inside error amplifier through resistances R3b , r1 and the terminal FB1 of the controller 1b.

A series circuit composed of a capacitor C9b and a capacitor C4b is interposed between one end of the discharge lamp 3 and the ground. A connection point between the capacitor C9b and the capacitor C4b is connected to a cathode of a diode D6b and an anode of a diode D7b. The diodes D6a, D7b and resistances R11, C11 constitute a rectifying-and-smoothing circuit that detects a voltage proportional to an output voltage VL2 and further outputs the detected voltage to the terminal OVP1 of the controller 1b.

The other end of the secondary winding S3 of the transformer T2 is connected to a cathode of a diode D1c and an anode of the diode D2c. The diodes D1c, D2c and a resistance R4c constitute a tube-current detecting circuit that detects a current I3 flowing in the secondary winding S3 and further outputs a voltage proportional to the detected current to one terminal of the inside error amplifier through resistances R3c, r1 and the terminal FB1 of the controller 1b.

A series circuit composed of a capacitor C9c and a capacitor C4c is interposed between one end of the discharge lamp 3 and the ground. A connection point between the capacitor C9c and the capacitor C4c is connected to a cathode of a diode D6c and an anode of a diode D7c. The diodes D6c, D7c and the resistances R11, C11 constitute a rectifying-and-smoothing circuit that detects a voltage proportional to an output voltage VL3 and further outputs the detected voltage to the terminal OVP1 of the controller 1b.

Note, a combined current composed of the currents I3 to I3 is outputted at one terminal of the inside error amplifier. Further, in the detected voltages VL1 to VL3, a highest voltage signal is outputted to the terminal OVP1 of the controller 1b.

(Re. Abnormality Detecting Circuit)

Next, the abnormality detecting circuit as one feature of the third embodiment will be described below. In FIG. 5B, an abnormality detecting circuit 7a is adapted so as to detect the abnormality of the discharge lamp 3 by comparing a terminal voltage at one end of the lamp 3 with another terminal voltage at the other end.

Notations “Cs1”, “Cs2” and “Cs3” denote respective stray capacitances between a panel and a flame ground. On one side of the discharge lamp 3a, a midpoint between the capacitor C9a and the capacitor C4a is connected to the anode of the diode Da1. In the diode Da1, its cathode is connected to one end of a capacitor Ca1, one end of a resistance Ra1 and one end of a resistance Rc1. The other end of the capacitor Ca1 is connected to ground. The other end of the resistance Ra1 is connected to one end of a resistance Rb1, while the other end of the resistance Rb1 is connected to ground. The other end of the resistance Rc1 is connected to one end of a resistance Rd1, while the other end of the resistance Rd1 is connected to ground.

A divided voltage at the connection point between the resistance Ra1 and the resistance Rb1 corresponds to a voltage obtained by dividing a both-end voltage of the capacitor Ca1 by the resistance Ra1 and the resistance Rb1. This divided voltage is outputted, as a first reference voltage Vb1, to a positive (+) input terminal of a comparator CP1. Similarly, a divided voltage at the connection point between the resistance Rc1 and the resistance Rd1 corresponds to a voltage obtained by dividing the both-end voltage of the capacitor Ca1 by the resistance Rc1 and the resistance Rd1. This divided voltage is outputted, as a first detection voltage Vc1, to a negative (−) input terminal of a comparator CP2.

On one side of the discharge lamp 3b , a midpoint between the capacitor C9b and the capacitor C4b is connected to the anode of the diode Da2. In the diode Da2, its cathode is connected to one end of a capacitor Ca2, one end of a resistance Ra2 and one end of a resistance Rc2. The other end of the capacitor Ca2 is connected to ground. The other end of the resistance Ra2 is connected to one end of a resistance Rb2, while the other end of the resistance Rb2 is connected to ground. The other end of the resistance Rc2 is connected to one end of a resistance Rd2, while the other end of the resistance Rd2 is connected to ground.

A divided voltage at the connection point between the resistance Ra2 and the resistance Rb2 corresponds to a voltage obtained by dividing a both-end voltage of the capacitor Ca2 by the resistance Ra2 and the resistance Rb2. This divided voltage is outputted, as a second reference voltage Vb2, to a positive (+) input terminal of the comparator CP2. Similarly, a divided voltage at the connection point between the resistance Rc2 and the resistance Rd2 corresponds to a voltage obtained by dividing the both-end voltage Va2 of the capacitor Ca2 by the resistance Rc2 and the resistance Rd2. This divided voltage is outputted, as a second detection voltage Vc2, to a negative (−) input terminal of a comparator CP3.

On one side of the discharge lamp 3c, a midpoint between the capacitor C9c and the capacitor C4c is connected to an anode of a diode Da3. In the diode Da3, its cathode is connected to one end of a capacitor Ca3, one end of a resistance Ra3 and one end of a resistance Rc3. The other end of the capacitor Ca3 is connected to ground. The other end of the resistance Ra3 is connected to one end of a resistance Rb3, while the other end of the resistance Rb3 is connected to ground. The other end of the resistance Rc3 is connected to one end of a resistance Rd3, while the other end of the resistance Rd3 is connected to ground.

A divided voltage at the connection point between the resistance Ra3 and the resistance Rb3 corresponds to a voltage obtained by dividing a both-end voltage of the capacitor Ca3 by the resistance Ra3 and the resistance Rb3. This divided voltage is outputted, as a third reference voltage Vb3, to a positive (+) input terminal of the comparator CP3. Similarly, a divided voltage at the connection point between the resistance Rc2 and the resistance Rd2 corresponds to a voltage obtained by dividing the both-end voltage Va2 of the capacitor Ca2 by the resistance Rc2 and the resistance Rd2. This divided voltage is outputted, as a third detection voltage Vc3, to a negative (−) input terminal of the comparator CP1.

All of the resistances Ra1, Rb1, Ra2, Rb2, Ra3, Rb3, the first reference voltage Vb1, the second reference voltage Vb2 and the third reference voltage Vb3 constitute a reference voltage part of the invention. While, all of the resistances Rc1, Rd1, Rc2, Rd2, Rc3, Rd3, the first detection voltage Vc1, the second detection voltage Vc2 and the third detection voltage Vc3 constitute a detection voltage part of the invention.

The comparator CP1 (a first determining part of the invention), which is a type of open collector, compares the first reference voltage Vb1 at the connection point between the resistance Ra1 and the resistance Rb1 with the third detection voltage Vc3 at the connection point between the resistance Rc3 and the resistance Rd3. If the third detection voltage Vc3 is outside a predetermined range with respect to the first reference voltage Vb1, then the comparator CP1 determines that either the discharge lamp 3a or the discharge lamp 3c is in its abnormal condition and further outputs the determination result to a terminal PRO of the controller 1b.

The comparator CP2 (a second determining part of the invention), which is also a type of open collector, compares the second reference voltage Vb2 at the connection point between the resistance Ra2 and the resistance Rb2 with the first detection voltage Vc1 at the connection point between the resistance Rc1 and the resistance Rd1. If the first detection voltage Vc1 is outside a predetermined range with respect to the second reference voltage Vb2, then the comparator CP2 determines that either the discharge lamp 3a or the discharge lamp 3b is in the abnormal condition and further outputs the determination result to the terminal PRO of the controller 1b.

The comparator CP3 (a third determining part of the invention), which is also a type of open collector, compares the third reference voltage Vb3 at the connection point between the resistance Ra3 and the resistance Rb3 with the second detection voltage Vc2 at the connection point between the resistance Rc2 and the resistance Rd2. If the second detection voltage Vc2 is outside a predetermined range with respect to the third reference voltage Vb3, then the comparator CP2 determines that either the discharge lamp 3b or the discharge lamp 3c is in the abnormal condition and further outputs the determination result to the terminal PRO of the controller 1b.

A series circuit composed of a resistance Re and a resistance Rf is connected between a power supply voltage REG and ground. A connection point between the resistance Re and the resistance Rf is connected to an output terminal of the comparator CP1, an output terminal of the comparator CP2 and an output terminal of the comparator CP3.

Assume, in this embodiment, there are established relationships as follows: Ra1/Rb1=Ra2/Rb2=Ra3/Rb3>Rc1/Rd1=Rc2/Rd2=Rc3/Rd3 and C9a/C4a=C9b/C4b=C9c/C4c.

Assuming that respective output terminals of the comparators CP1 to CP3 are represented by p, q and r respectively, as shown in FIG. 6, each of the comparators CP1 to CP3 outputs either a H-level signal or a L-level signal. Further, in the arrangement shown in FIG. 6, the discharge lamps 3a to 3c comprise cold cathode fluorescent lamps (i.e. CCFL1, CCFL2 and CCFL3), respectively.

When all of the CCFL1 to the CCFL3 are normally operated, the outputs of the comparators CP1 to CP3 represent H-level in common. On the contrary, if the voltage of the CCFL1 browns out, then only the output of the comparator CP1 represents L-level. If the voltage of the CCFL2 browns out, only the output of the comparator CP2 represents L-level. If the voltage of the CCFL3 browns out, only the output of the comparator CP3 represents L-level.

If two cold cathode fluorescent lamps are subjected to simultaneous brownout in voltage, it is believed that an input to a comparator for comparing two voltages related to the relevant lamps would vary depending on respective decreasing levels of the lamps.

In even the case, however, the other comparator would output a L-level signal. For instance, if the voltages of the CCFL1 and the CCFL2 fall off together, the output of the CP1 becomes L-level. Note, under condition that two cold cathode fluorescent lamps are subjected to brownout simultaneously (for example, in a situation that the voltages of the CCFL1 and the CCFL2 fall off together), if the brownout of the CCFL2 gets larger than the brownout of the CCFL1 so as to exceed the resistance ratio in the voltage divider, the output of the CP2 becomes L-level.

Therefore, it is noted that there is extremely-low probability that all of the three discharge lamps are brought into the abnormal condition. If any, however, any of CP1 to CP3 would output a L-level signal so long as a difference in potential is produced among the voltages of the CCFL1 to the CCFL3. Accordingly, in such a case, it is possible to accomplish a safe and optimal protection of the discharge lamps.

In the third embodiment, as mentioned above, the abnormality detecting circuit 7a is provided with three reference voltage parts (Ra1, Rb1, Ra2, Rb2, Ra3, Rb3), three detection voltage parts (Rc1, Rd1, Rc2, Rd2, Rc3, Rd3) and three comparators CP1 to CP3 corresponding to three discharge lamps 3a to 3c. Without being limited to this embodiment, however, the number of discharge lamps has only to be two or more. Then, if only providing the reference voltage parts as many as the discharge lamps, the detection voltage parts as many as the discharge lamps and the comparators as many as the discharge lamps, the same operation and effect as those in the third embodiment would be accomplished.

Finally, it will be understood by those skilled in the art that the foregoing descriptions are nothing but three embodiments of the disclosed discharge lamp lighter and therefore, various changes and modifications may be made within the contents of the present invention.

This application is based upon the Japanese Patent Application No. 2007-212831, filed on Aug. 17, 2007, the entire content of which is incorporated by reference herein.

What is claimed is:

1. A discharge lamp lighter for outputting voltages to both ends of a discharge lamp, comprising:
an abnormality detecting circuit for detecting an abnormality in an electrical load, the abnormality detecting circuit including:
a reference voltage part for generating a first reference voltage obtained by dividing a voltage, which has been obtained as a result of rectifying and smoothening a terminal voltage at one end of the discharge lamp, by a first constant ratio, and a second reference voltage obtained by dividing another voltage, which has been obtained as a result of rectifying and smoothening another terminal voltage at the other end of the discharge lamp, by the first constant ratio;
a detection voltage part for generating a first detection voltage obtained by dividing the voltage, which has been obtained as a result of rectifying and smoothening the terminal voltage at one end of the discharge lamp, by a second constant ratio, and a second detection voltage obtained by dividing the other voltage, which has been obtained as a result of rectifying and smoothening the other terminal voltage at the other end of the discharge lamp, by the second constant ratio;
a first determining part for determining that the electrical load has an abnormality when the second detection voltage is outside a predetermined range with respect to the first reference voltage; and
a second determining part for determining that the electrical load has an abnormality when the first detection voltage is outside the predetermined range with respect to the second reference voltage.

2. The discharge lamp lighter of claim 1, wherein voltages in opposite phase are outputted to both ends of the discharge lamp.

3. The discharge lamp lighter of claim 1, wherein the first determining part and the second determining part comprise open collector type comparators respectively.

4. The discharge lamp lighter of claim 1, wherein the discharge lamp is a cold cathode fluorescent lamp.

5. The discharge lamp lighter of claim 1, wherein the discharge lamp is an external electrode fluorescent lamp.

6. A discharge lamp lighter for outputting voltages to respective one ends of multiple (N: N≧2) discharge lamps, comprising:
an abnormality detecting circuit for detecting an abnormality in an electrical load, the abnormality detecting circuit including, on sequential definition of the discharge lamps as a first discharge lamp˜an N^{th}. discharge lamp:
a reference voltage part for generating a first reference voltage˜an N^{th}. reference voltage obtained by dividing voltages, which have been obtained as a result of rectifying and smoothening terminal voltages at respective one ends of the discharge lamps, by a first constant ratio;
a detection voltage part for generating a first detection voltage˜an N^{th}. detection voltage obtained by dividing the voltages, which have been obtained as a result of rectifying and smoothening the terminal voltages at respective one ends of the discharge lamps, by a second constant ratio; and
multiple (N) determining parts for determining that the electrical load has an abnormality, each of the determining parts being adapted so as to:
select one detection voltage from the first detection voltage˜the N^{th}. detection voltage and also one reference voltage from the first reference voltage˜then N^{th}. reference voltage, the selected detection voltage having its sequential number different from a sequential number of the selected reference voltage;
compare the selected detection voltage with the selected reference voltage; and
determine that the electrical load has an abnormality when the selected detection voltage is outside the predetermined range with respect to the selected reference voltage.

7. The discharge lamp lighter of claim 6, wherein the multiple determining parts comprise open collector type comparators respectively.

8. The discharge lamp lighter of claim 6, wherein the discharge lamps are cold cathode fluorescent lamps.

9. The discharge lamp lighter of claim 6, wherein the discharge lamps are external electrode fluorescent lamps.
